(19) United States
(12) Patent Application Publication
(10) Pub. No.: US 2012/0301784 A1
(43) Pub. Date: Nov. 29, 2012

(54) NONAQUEOUS SECONDARY BATTERY

(76) Inventors: Akira YANO, Kyoto (JP); Yuji SASAKI, Kyoto (JP); Katsunori KOJIMA, Kyoto (JP); Fusaji KITA, Kyoto (JP)

(21) Appl. No.: 13/478,506

(22) Filed: May 23, 2012

(30) Foreign Application Priority Data
May 24, 2011 (JP) 2011-115348

(51) Int. Cl. H01M 10/052; H01M 4/485; H01M 4/60; B82Y 30/00

(52) U.S. Cl. 429/213; 977/742

(57) ABSTRACT

The nonaqueous secondary battery of the present invention comprises a positive electrode having a positive electrode mixture layer containing a lithium-containing composite oxide as a positive electrode active material, a negative electrode, a separator, and a nonaqueous electrolyte. The surface of the positive electrode active material or the positive electrode mixture layer is coated with polyvalent organic metal salt, particularly preferably with fluorine-containing polyvalent organic lithium salt.

### BACKGROUND OF THE INVENTION

1. Field of the Invention

The present invention relates to a nonaqueous secondary battery capable of exhibiting excellent charge/discharge cycle characteristics even when being charged to a high voltage.

2. Description of Related Art

With the development of portable electronic devices such as portable phones and notebook personal computers and the commercialization of electric vehicles in recent years, there are needs for small, lightweight and high-capacity secondary batteries. As high-capacity secondary batteries that can satisfy such needs at present, nonaqueous secondary batteries (lithium-ion secondary batteries) using lithium-containing composite oxides such as LiCoO₂ as positive electrode active materials and using carbon materials as negative electrode active materials have been introduced to the market. And as devices to which nonaqueous secondary batteries are applied are making further advancement, a larger capacity and larger energy density, for example, are required of nonaqueous secondary batteries.

To increase the energy density of a battery, high-capacity positive electrode active materials or positive electrode active materials capable of functioning at a high potential may be used. From the viewpoint of the latter, lithium-cobalt oxides with increased final voltage and spinel lithium-manganese oxides capable of functioning at a high potential are studied at present.

For example, LiCoO₂ is generally charged at a voltage of 4.3V or less against lithium when being used but it has been reported that oxides obtained from the partial replacement of Co of LiCoO₂ with other metal element can be charged/discharged even at a voltage of 4.4V or higher. Further, it has been found that the lithium-containing composite oxide represented by the general formula LiNiₓM_{y}Mn_{2-x-y}O₄ (where M is at least one transition metal element other than Ni and Mn, x satisfies 0.4≦x≦0.6, and y satisfies 0≦y≦0.1) can function at a potential of 4.5V or higher against lithium (e.g., JP 9-147867 A and JP 11-73962 A).

However, when the lithium-containing composite oxide represented by the general formula LiNiₓM_{y}Mn_{2-x-y}O₄ discussed above or other positive electrode active material is used to form a battery, and the battery is charged at a high voltage, the positive electrode active material reacts with a nonaqueous electrolyte, which may lead to the deterioration of the charge/discharge cycle characteristics of the battery. Such deterioration of the charge/discharge cycle characteristics is more likely to occur when the battery is charged to 4.4V or higher against lithium, it is even more likely to occur when the battery is charged to 4.5V or higher against lithium, and the deterioration becomes particularly significant when the battery is charged to 5V or higher against lithium.

With the foregoing in mind, the present invention provides a nonaqueous secondary battery capable of exhibiting excellent charge/discharge cycle characteristics even when being charged at a high voltage.

### SUMMARY OF THE INVENTION

A first nonaqueous secondary battery of the present invention comprises a positive electrode having a positive electrode mixture layer containing a lithium-containing composite oxide as a positive electrode active material, a negative electrode, a separator and a nonaqueous electrolyte. The surface of the positive electrode active material is coated with polyvalent organic metal salt.

A second nonaqueous secondary battery of the present invention comprises a positive electrode having a positive electrode mixture layer containing a lithium-containing composite oxide as a positive electrode active material, a negative electrode, a separator and a nonaqueous electrolyte. The surface of the positive electrode mixture layer is coated with polyvalent organic metal salt.

According to the present invention, it is possible to provide a nonaqueous secondary battery capable of exhibiting excellent charge/discharge cycle characteristics even when being charged at a high voltage.

### BRIEF DESCRIPTION OF THE DRAWING

FIG. 1 is a plan view of the nonaqueous secondary battery of the present invention.

### DETAILED DESCRIPTION OF THE INVENTION

The nonaqueous secondary battery of the present invention comprises a positive electrode having a positive electrode mixture layer containing a lithium-containing composite oxide as a positive electrode active material, a negative electrode, a separator and a nonaqueous electrolyte. The surface of the positive electrode active material or the surface of the positive electrode mixture layer is coated with polyvalent organic metal salt.

Even if the nonaqueous secondary battery is charged to a high voltage (e.g., 4.3V or higher, preferably 4.4V or higher, more preferably 4.5V or higher, and most preferably 5V or higher against lithium), the deterioration of the charge/discharge cycle characteristics can be suppressed because, in the positive electrode of the nonaqueous secondary battery, the surface of the positive electrode active material or the surface of the positive electrode mixture layer is coated with the polyvalent organic metal salt.

In comparison to generally used electrolyte salts such as monovalent organic metal salts including, for example, LiPF₆ and LiBF₄, polyvalent organic metal salts have higher adherence to the surface of positive electrode active materials and to the surface of positive electrode mixture layers. Thus, the surface of the positive electrode active material and the surface of the positive electrode mixture layer can be coated favorably in the positive electrode mixture layer, and a reaction between the positive electrode active material and a nonaqueous electrolyte can thus be suppressed adequately. For this reason, it is believed that the deterioration of the charge/discharge cycle characteristics can be suppressed even if the battery is charged to a high voltage as above.

In terms of suppressing the reaction between the positive electrode active material and the nonaqueous electrolyte, it is preferable that the surface of the positive electrode active material is coated with the polyvalent organic metal salt and the surface of the positive electrode mixture layer is also coated with the polyvalent organic metal salt. That is, it is preferable that the positive electrode mixture layer as a whole contains the polyvalent organic metal salt, and the proportion of the polyvalent organic metal salt contained in a surface part of the positive electrode mixture layer is larger than that of the polyvalent organic metal salt contained in an interior part of the positive electrode mixture layer.

The term “surface part of the positive electrode mixture layer” as used herein refers to a part whose range is up to 10 μm in depth from the surface of the positive electrode mixture layer. Further, the term “interior part of the positive electrode mixture layer” as used herein refers to a part of the positive electrode mixture layer located inward relative to the surface part, i.e., a part, in a case where the positive electrode mixture layer is formed on a current collector, located closer to the current collector than the surface part.

If the surface of the positive electrode active material is coated with a large amount of organic metal salt, necessary cell reaction may not proceed adequately as movements of ions may be disrupted on the surface of the positive electrode active material, and the battery characteristics may thus deteriorate. However, since the organic lithium salt used in the nonaqueous secondary battery of the present invention is polyvalent, ions can move smoothly on the surface of the positive electrode active material. For this reason, it is believed that the deterioration of battery characteristics can be suppressed favorably. Further, since the polyvalent organic metal salt has excellent adherence, the surface of the positive electrode active material and the surface of the positive electrode mixture layer can be coated favorably even with a small amount of polyvalent organic metal salt. Thus, it is considered that the reaction between the positive electrode active material and the nonaqueous electrolyte can be suppressed without causing the deterioration of the battery characteristics.

As long as the organic metal salt according to the present invention is polyvalent, it may be organic metal salt having a bivalent or higher metal ion or organic metal salt having a plurality of monovalent metal ions. Specifically, the organic metal salt according to the present invention may be, for example, bivalent, trivalent, or quadrivalent organic metal salt. Furthermore, in order to prevent the polyvalent organic metal salt from leaching into the nonaqueous electrolyte (e.g., a nonaqueous electrolyte in the liquid form), it is desirable that the polyvalent organic metal salt has poorer solubility in the nonaqueous electrolyte than that of generally used electrolyte salts such as LiPF₆ and LiBF₄.

Specific examples of the polyvalent organic metal salt include organic metal salts represented by the general formula [R¹(Y)ₐ]_{b}M_{c}, where R¹ is an organic group such as an alkyl group, alkylene group, or aromatic group, and hydrogen atoms of any of these organic groups may partially or entirely be replaced with fluorine atoms. “a” is an integer of 2 or more. Y is an acid metal salt group. Specific examples of Y include —SO₃⁻, —CO₂⁻, —PO₄⁻, —PF_{d}Rf_{5-d}⁻ [where Rf is a fluorine-substituted alkyl group (the same is true in the following) and “d” is an integer of 5 or less (the same is true in the following)], —BFₑRf₃₋ₑ⁻ [where “e” is an integer of 3 or less (the same is true in the following)], and —R_{g}PO₄⁻ [ where R is an organic residue (the same is true in the following) and may be bonded to R₁. “g” is 0 or 1 (the same is true in the following).].

Y in the above general formula may be one of those mentioned above or may be two or more of those mentioned above as the examples. Further, M in the above general formula is a metal element such as alkali metal, alkaline earth metal, transition metal or group 13 element, for example, Li, Na, K, Mg, Ca, Mn, Al, etc. M is desirably alkali metal or alkaline earth metal, more desirably alkali metal, and most desirably lithium. That is, it is most desirable that the polyvalent organic metal salt is polyvalent organic lithium salt. “b” and “c” in the above general formula are each an integer that is determined based on the valence of the metal M and the valence of [R¹(Y)ₐ].

The polyvalent organic lithium salts represented by the above general formula may contain a hydroxyl group (—OH) and/or an acid group (e.g., —SO₃H, —CO₂H) in the organic group R¹. However, since these groups may undergo reaction in the battery, the number of these groups is preferably smaller than that of the acid metal salt group(s), and is more preferably 1/10 or less of the number of the acid metal salt group(s).

When the molecular weight of R¹ in the above general formula is too large, the coating becomes difficult to carry out effectively. For this reason, the molecular weight of R¹ is desirably 100,000 or less, more desirably 2,000 or less, and most desirably 500 or less. Further, when the molecular weight of R¹ in the above general formula is too small, a coating with poor ion permeability may be formed. For this reason, the molecular weight of R¹ is desirably 30 or more, more desirably 50 or more, and most desirably 70 or more. R¹ may be alkylene or aromatic group, or organic composite primarily composed of alkylene and/or aromatic group, and examples of R¹ include: alkylenes represented by —CₕH₂ₕ₋ᵢFᵢ— (where “h” and “1” are each an integer, and “h” and “i” satisfy h≧1 and i≧0, respectively) such as —CH₂CH₂CH₂CH₂—, —CHFCH₂CH₂CH₂—, and —CF₂CF₂CF₂CF₂—; aromatic groups represented by —(C₆H₄₋ⱼFₖ)ₗ(C₆H₄₋ₘFₙ)ᵤ— [where “j”, “k”, “l”, “m”, “n” and “u” are each an integer and satisfy j≧0, k≧0, k≦j, m≧0, n≧0, n≦m, and 1+u≧1, respectively] such as —C₆H₄—, >C₆H₃—, —C₆H₄—C₆H₄—, —C₆H₃F—, and —C₆F₄—; and organic composites such as >C₆H₃—C(CF₃)₂—C₆H₃<, >C₆H₃—CF₃, —C₆H₄—C(CF₃)₂—C₆H₄—, R²(CH₂CH₂—C₆H₄—)ₙR³ [where R² and R³ are each an organic group].

More specific examples of the polyvalent organic metal salt include organic metal salts having alkylene and/or aromatic group as R¹ and —SO₃⁻, —CO₂⁻ or —PO₄⁻ as Y.

Further, the polyvalent organic metal salt more preferably contains a fluorine atom. Examples of such polyvalent organic metal salt include organic lithium salts having alkylene or aromatic group or both whose hydrogen atoms are partially or entirely replaced with fluorine atoms, and —SO₃Li, —CO₂Li, —PF_{d}Rf_{5-d}Li, —BFₑRf₃₋ₑLi, —Rf_{3-g}PO₄Li_{g}, or the like at both terminals of the alkylene or aromatic group or the both.

More specifically, organic lithium salts represented by the general formula R⁴—(R⁵)ₒ—(C_{q}FᵣHₛY²)ₚ—R⁶ [where R⁴ and R⁶ are each a hydrogen atom or alkyl group (hydrogen atoms of the alkyl group may partially or entirely be replaced with fluorine atoms), and R⁴ and R⁶ may be the same or may be different from each other. R⁵ is, for example, an organic chain such as alkylene (hydrogen atoms of the organic chain may partially or entirely be replaced with fluorine atoms), and Y² is —SO₃Li, —CO₂Li, —PF_{d}Rf_{5-d}Li, —BFₑRf₃₋ₑLi, —Rf_{3-g}PO₄Li_{g}, —N(RfSO₂)Li, or —C(RfSO₂)₂Li. “o”, “q”, “r” and “s” each are an integer of 0 or more, and “p” is an integer of 2 or more.] can also be used.

More preferred examples of the polyvalent organic lithium salt include organic lithium salts such as LiSO₃—Rf′—SO₃Li, LiCO₂—Rf′—CO₂Li, LiPF₅—Rf′—PF₅Li, and LiBF₃—Rf′—BF₃Li (where Rf′ is an organic chain such as alkylene, aromatic chain, or aromatic-containing alkylene whose hydrogen atoms are partially or entirely replaced with fluorine atoms).

As ways to coat the surface of the positive electrode active material or the surface of the positive electrode mixture layer with the polyvalent organic metal salt, for example, the positive electrode active material is mixed with a solution in which the polyvalent organic metal salt is dissolved and the polyvalent organic metal salt is applied to the positive electrode mixture layer formed.

Further, as described above, the proportion of the polyvalent organic metal salt contained in the positive electrode mixture layer is desirably larger in the surface part of the positive electrode mixture layer then in the interior part of the positive electrode mixture layer because this allows adequate suppression of the reaction between the nonaqueous electrolyte and the positive electrode on the surface of the positive electrode mixture layer. At the same time, transport of ions such as lithium is less likely to be disrupted in the interior part of the positive electrode mixture layer because the proportion of the polyvalent organic metal salt contained therein is small. As a way to increase the proportion of the polyvalent organic metal salt contained in the surface part of the positive electrode mixture layer, the polyvalent organic metal salt may be applied to the positive electrode mixture layer formed, for example. Further, the positive electrode mixture layer may be formed by multilayer application, using a paint with a high polyvalent organic metal salt content (positive electrode mixture containing paste described later; the same is true in the following) as a paint for forming the surface part of the positive electrode mixture layer.

The amount of the polyvalent organic metal salt in the positive electrode mixture layer as a whole is preferably 0.01 mass % or more, more preferably 0.05 mass % or more, and even more preferably 0.1 mass % or more with respect to 100 parts by mass of the positive electrode active material in terms of making full use of the effects of the polyvalent organic metal salt. However, when the amount of the polyvalent organic metal salt in the positive electrode mixture layer is excessive, the amount of the positive electrode active material declines, and the capacity may thus drop. For this reason, the amount of the polyvalent organic metal salt contained in the positive electrode mixture layer as a whole is preferably 5 mass % or less, more preferably 2 mass % or less, and even more preferably 1 mass % or less with respect to 100 parts by mass of the positive electrode active material. Therefore, it is desirable to adjust the amount of the polyvalent organic metal salt used in coating the positive electrode active material and the positive electrode mixture layer to be in the preferred range when forming the positive electrode mixture layer.

The positive electrode of the nonaqueous secondary battery of the present invention uses a lithium-containing composite oxide as the positive electrode active material and includes, for example, a current collector and the positive electrode mixture layer formed on one side or both sides of the current collector and containing the positive electrode active material, a conductive assistant, a binder, and the like.

Examples of the positive electrode active material include lithium-containing composite oxides such as LiCoO₂ used at a voltage of 4.3V or less against lithium, lithium-containing composite oxides usable at a voltage of 4.4V or higher against lithium [e.g., those obtained from the partial replacement of Co of LiCoO₂ with other metal elements such as Ti, Zr, Mg and Al, or lithium-manganese oxides obtained from the replacement of a manganese site with other metal elements, for example, composite oxides represented by the general formula LiNiₓM_{y}Mn_{2-x-y}O₄ (where M is at least one metal element other than Ni, Mn, and Li, x satisfies 0.4≦x, and y satisfies 0≦y≦0.4)] and lithium-containing composite oxides usable even at a voltage of 5V or higher against lithium, for example, composite oxide represented by the general formula LiNiₓM_{y}Mn_{2-x-y}O₄, where x satisfies 0.4≦x≦0.6, and y satisfies 0≦y≦0.1. The metal element M in the above general formula is preferably any of Cr, Fe, Co, Cu, Zn, Ti, Al, Mg, Ca, and Ba. Among these, Fe and Co are more preferred because more favorable characteristics can be achieved. For the positive electrode active material used in the positive electrode according to the present invention, these lithium-containing composite oxides may be used individually or in combination of two or more. Among these positive electrode active materials, lithium-containing composite oxides chargeable at a high voltage and whose structure is stable even at a voltage higher than 4.3V against lithium are preferred because the capacity of the battery can be increased.

Generally, the deterioration of the charge/discharge cycle characteristics of a battery caused by a reaction between a positive electrode active material and a nonaqueous electrolyte in the battery becomes more significant at a higher charging voltage. However, in the nonaqueous secondary battery of the present invention, the deterioration of the charge/discharge cycle characteristics can be favorably suppressed even when the charging voltage is 4.5V or higher because of the effects resulting from the polyvalent organic lithium salt as discussed above. Thus, the effects manifest themselves noticeably when a lithium-containing composite oxide usable at a higher voltage is used in the present invention.

The phrase “useable at a voltage of 4.4V or higher against lithium” as used herein means that the material can be charged, without any problems, to 4.4V at a constant current of 0.2 C, and then at a constant voltage of 4.4V for a total of 8 hours (total time of the constant current charging and the constant voltage charging).

Generally, the positive electrode mixture layer of the positive electrode includes conductive assistants. As in conventional nonaqueous secondary batteries, graphites, carbon blacks (e.g., acetylene black and Ketjen Black), amorphous carbon materials such as carbon materials with amorphous carbon being formed thereon, fibrous carbons (e.g., vapor-grown carbon fibers and carbon fibers obtained by spinning pitch and carbonizing the spun pitch), and carbon nanotubes (a variety of carbon nanotubes including multilayer and single layer carbon nanotubes) can be used as conductive assistants for use in the positive electrode. These materials may be used individually or in combination of two more as conductive assistants for use in the positive electrode.

Among the conductive assistants mentioned above, it is preferable to use an amorphous carbon material and fibrous carbon or carbon nanotube in combination. The positive electrode using such conductive assistants can result in a nonaqueous secondary battery with improved charged/discharge cycle characteristics and load characteristics.

For example, when graphite is used as a positive electrode conductive assistant to form a battery, and the battery is charged to 4.5V or higher, intercalation of anions into graphite from a nonaqueous electrolyte, for example, intercalation of PF₆⁻ complex ions into graphite occurs, as expressed by the following formula: C₂₄+PF₆⁻→C₂₄(PF₆)+e⁻.

When the above reaction occurs, the interlayer distance of graphite is widened and graphite particles expand, causing a gap between the positive electrode active material and the graphite particles. As a result, graphite loses its function as a conductive assistant, and the charge/discharge cycle characteristics of the positive electrode may thus deteriorate. However, when an amorphous carbon material is used as a conductive assistant in combination with graphite, changes in the crystal size are less likely to occur even if the intercalation of PF₆⁻ complex ions takes place. For this reason, the conductivity within the positive electrode mixture layer can be favorably maintained.

However, since amorphous carbon materials generally have a large specific surface area and their bulk is large, it is difficult to increase the density of a positive electrode mixture layer when an amorphous carbon material is used in the positive electrode mixture layer and an increase in the capacity of the battery may thus be prevented. However, by using fibrous carbon or carbon nanotube together with an amorphous carbon material, the filling property of the conductive assistants in the positive electrode mixture layer can be improved. As a result, the capacity of the battery can be further increased while the effects resulting from the use of amorphous carbon material can be ensured.

The amorphous carbon material preferably has an average particle size of 1 μm or less and more preferably 100 nm or less. This is because particles of an amorphous carbon material having such an average particle size can easily burrow their way into space between positive electrode active material particles when forming a positive electrode mixture layer, and the filling property is improved. The amorphous carbon material's ability to retain a nonaqueous electrolyte becomes higher as its average particle size is smaller, and thus the characteristics of the positive electrode can be improved. However, since it is difficult to produce extremely small amorphous carbon materials, those having an average particle size of down to about 1 nm are practical.

In terms of improving the filling property of the positive electrode mixture layer to facilitate an increase in the filling rate, fibrous carbon and carbon nanotube have an average particle size of preferably 10 μm or less, more preferably 1 μm or less, and even more preferably 100 nm or less. Further, fibrous carbon and carbon nanotube have an average particle size of preferably 10 nm or more.

The average particle size of each of the amorphous carbon material, fibrous carbon, carbon nanotube and lithium-containing composite oxide (described below) as used herein refers to D50 as the value of the diameter of particles with an accumulated volume percentage of 50% on a volume basis measured by a laser diffraction/scattering particle size distribution analyzer.

When using an amorphous carbon material and a fibrous carbon material or carbon nanotube in combination, the amorphous carbon material makes up preferably 15 mass % or more, more preferably 30 mass % or more and even more preferably 50 mass % or more of all of the conductive assistants used in the positive electrode in terms of amount. When the amorphous carbon material is used in such an amount, changes in the lattice size can be suppressed even if, for example, the intercalation of PF₆⁻ complex ions into the carbon materials occurs, so that favorable conductivity can be maintained. However, when the amount of the amorphous carbon material is excessive, the density of the positive electrode mixture layer may decline. For this reason, the amorphous carbon material makes up preferably 85 mass % or less of all of the conductive assistants used in the positive electrode in terms of amount.

In order to increase the density of the positive electrode mixture layer to increase the capacity of the positive electrode, the lithium-containing composite oxide as the positive electrode active material has an average particle size of preferably 0.05 to 30 μm, and it is preferable that the average particle size of each conductive assistant is smaller than or equal to that of the lithium-containing composite oxide. That is, it is preferable that the lithium-containing composite oxide and each conductive assistant establish the relationship Rg≦Rm, where Rm (nm) is the average particle size of the lithium-containing composite oxide and Rg (nm) is the average particle size of each conductive assistant.

It is preferable that the positive electrode according to the present invention is produced by, for example, mixing the lithium-containing composite oxide as the positive electrode active material, conductive assistants, a binder, and the like with each other to obtain a positive electrode mixture, dispersing the positive electrode mixture in a solvent to prepare a positive electrode mixture containing paste (in this case, the binder may have already been dissolved or dispersed in the solvent), applying the positive electrode mixture containing paste onto the surface of a current collector made of a metal foil, drying the applied paste to form a positive electrode mixture layer, and optionally applying pressure to the positive electrode mixture layer. Further, when using an amorphous carbon material and fibrous carbon or carbon nanotube in combination as the conductive assistants as discussed above, it is preferable to mix the amorphous carbon material and fibrous carbon or carbon nanotube with each other in advance of mixing the components to obtain the positive electrode mixture. This more favorably ensures the effects resulting from the combined use of the amorphous carbon material and fibrous carbon or carbon nanotube. It should be noted that the method of producing the positive electrode according to the present invention is not limited to this, and the positive electrode may be produced by other methods. Examples of binders for use in the positive electrode include polyvinylidene fluoride (PVDF), polytetrafluoroethylene, polyacrylic acid, and styrene-butadiene rubber.

In order to improve the stability of the positive electrode mixture containing paste, it is desirable to coat the surface of the lithium-containing composite oxide with the polyvalent organic metal salt in advance of preparing the paste, and it is preferable that the polyvalent organic metal salt is adhered to the surface of the positive electrode active material in advance by dissolving the polyvalent organic metal salt in a solvent, such as water, to prepare a solution, immersing the lithium-containing composite oxide in the solution, taking out the lithium-containing composite oxide from the solution and drying the lithium-containing composite oxide. Further, when coating the surface of the positive electrode mixture layer with the polyvalent organic metal salt, the polyvalent organic metal salt may be adhered to the surface of the positive electrode mixture layer by applying to the surface of the positive electrode mixture layer formed a solution prepared by dissolving the polyvalent organic metal salt in water or the like, and drying the applied solution.

The surface of the lithium-containing composite oxide and the surface of the positive electrode mixture layer may also be coated with an organic compound other than the polyvalent organic metal salt or with an inorganic compound such as Al₂O₃, AlPO₄, ZrO₂, or AlOOH, and can also be coated with a mixture of the polyvalent organic metal salt and an inorganic compound or organic compound other than the polyvalent organic metal salt.

In the positive electrode mixture layer of the positive electrode, it is preferable that the amount of the lithium-containing composite oxide as the positive electrode active material is 70 to 99 mass %, and the amount of the binder is 1 to 30 mass %, for example. Further, when using conductive assistants, the amount of the conductive assistants in the positive electrode mixture layer is preferably 1 to 20 mass %. Furthermore, the thickness of the positive electrode mixture layer is preferably 1 to 100 μm per one side of the current collector.

For the current collector of the positive electrode, a metal foil, punched metal, expanded metal, metal mesh or the like made of aluminum, stainless steel, nickel, titanium or alloy thereof can be used. Generally, an aluminum foil having a thickness of 10 to 30 μm is suitably used.

For the negative electrode of the nonaqueous secondary battery of the present invention, it is possible to use a negative electrode including, for example, a current collector and a negative electrode mixture layer formed on one side or both sides of the current collector and containing a negative electrode active material, a binder and the like.

The negative electrode active material is not particularly limited as long as it is capable of doping and de-doping lithium ions. Example of the negative electrode active material include carbon materials such as graphites, pyrolytic carbons, cokes, glassy carbons, calcinated organic polymer compounds, mesocarbon microbeads, carbon fibers and active carbons. Further, lithium or lithium-containing compounds can also be used as the negative electrode active material. Examples of lithium-containing compounds include tin oxides, silicon oxides, nickel-silicon alloy, magnesium-silicon alloy, tungsten oxides, and lithium-iron composite oxides as well as lithium alloys such as lithium-aluminum alloy, lithium-zinc alloy, lithium-indium alloy, lithium-gallium alloy, and lithium-indium-gallium alloy. When produced, some of these negative electrode active materials may not contain lithium, but they will contain lithium when being charged.

The negative electrode is produced by, for example, mixing the negative electrode active material and an optionally-added conductive assistant (e.g., one similar to those discussed above in connection with the positive electrode) and a binder (e.g., one similar to those discussed above in connection with the positive electrode) with each other to obtain a negative electrode mixture, dispersing the negative electrode mixture in a solvent to prepare a negative electrode mixture containing paste (the binder may have been already dissolved or dispersed in the solvent), applying the negative electrode mixture containing paste onto the surface of a current collector, drying the applied paste to form a negative electrode mixture layer, and optionally applying pressure to the negative electrode mixture layer. It should be noted that the method of producing the negative electrode is not limited to this, and the negative electrode may be produced by other methods.

In the negative electrode mixture layer of the negative electrode, it is preferable that the amount of the negative electrode active material is 70 to 99 mass % and the amount of the binder is 1 to 30 mass %, for example. Further, when using a conductive assistant, the amount of the conductive assistant in the negative electrode mixture layer is preferably 1 to 20 mass %. Furthermore, the thickness of the negative electrode mixture layer is preferably 1 to 100 μm per one side of the current collector.

As the current collector of the negative electrode, a metal foil, punched metal, expanded metal, metal mesh or the like made of copper, stainless steel, nickel, titanium or alloy thereof can be used. Generally, a copper foil having a thickness of 5 to 30 μm is suitably used.

For example, the positive electrode and the negative electrode discussed above are laminated via a separator and used in the form of a laminated electrode body or in the form of a wound electrode body obtained by further winding the laminated electrode body spirally.

The separator desirably has adequate strength and is capable of retaining an electrolyte in large amount. Thus, from such a viewpoint, it is preferable to use a microporous film or unwoven fabric including polyethylene, polypropylene or ethylene-propylene copolymer and having a thickness of 10 to 50 μm and a porosity of 30 to 70%.

For the nonaqueous electrolyte, a nonaqueous electrolytic solution obtained by dissolving electrolyte salt, such as lithium salt, in an organic solvent is used. The organic solvent is not particularly limited, and examples of the organic solvent include: chain esters such as dimethyl carbonate, diethyl carbonate, ethyl methyl carbonate, and methyl propyl carbonate; cyclic esters with a high dielectric constant such as ethylene carbonate, propylene carbonate, butylene carbonate and vinylene carbonate; and mixed solvents of chain esters and cyclic esters. A mixed solvent of chain ester and cyclic ester with the chain ester being the main solvent is particularly suitable. Further, solvents whose hydrogen atoms are partially replaced with fluorine atoms (hereinafter they are referred to as “fluorinated solvents”) and additives can also be used. Examples of fluorinated solvents include: fluorinated ethers such as C₃F₇OCH₃ and the one known as “Daikin D2”; fluorinated ethers such as HCF₂CF₂CF₂OCF₂CHF₂; carbonates such as fluoroethylene carbonate (F-EC), difluoroethylene carbonate (DFEC), trifluoromethyl ethylene carbonate (CF₃-EC), and fluorinated chain carbonate; fluorinated esters; and fluorinated nitriles. Among these, fluorinated ethers and fluorinated carbonates are desirable, and fluorinated ethers are particularly desirable.

The amount of the fluorinated solvent used is not limited as long as the nonaqueous electrolyte has a fluorinated solvent content of 0.5 vol % or more, where the total amount of the solvents of the nonaqueous electrolyte is 100 vol %. However, the fluorinated solvent content is desirably 5 vol % or more, more desirably 10 vol % or more, and most desirably 20 vol % or more. It should be noted, however, that an excessive fluorinated solvent content leads to the deterioration of the battery characteristics. Thus, the nonaqueous electrolyte has a fluorinated solvent content of desirably 60 vol % or less, more desirably 50 vol % or less, and most desirably 40 vol % or less, where the total amount of the solvents of the nonaqueous electrolyte is 100 vol %. Generally, a SEI (Solid Electrolyte Interface) coating as a coating principally composed of a lithium compound is formed on the surface of an electrode as a battery is charged/discharged. One of the effects resulting from the addition of the fluorinated solvent is that a SEI coating on the electrode can be reformed with a small amount of the fluorinated solvent. When the fluorinated solvent is used in combination with the polyvalent organic salt according to the present invention, the fluorinated solvent reduces the solubility of the polyvalent organic metal salt and improves the stability of the coating, so that the charge/discharge cycle characteristics can be improved more favorably.

Examples of electrolyte salts to be dissolved in the organic solvent in preparing the nonaqueous electrolyte include LiPF₆, LiBF₄, LiAsF₆, LiSbF₆, LiCF₃SO₃, LiC₄F₉SO₃, LiCF₃CO₂, Li₂C₂F₄(SO₃)₂, LiCnF₂ₙ₊₁SO₃ (where n satisfies 2≦n≦7), LiN(Rf¹SO₂)(Rf²SO₂), LiC(Rf¹SO₂)₃, and LiN(Rf¹OSO₂)₂ [where Rf¹ and Rf² are each a fluoroalkyl group]. These electrolyte salts may used individually or in combination of two or more. Note that Li₂C₂F₄(SO₃)₂ is treated herein as an electrolyte salt even though it is a polyvalent organic metal salt. This is because Li₂C₂F₄(SO₃)₂ is highly soluble in an electrolyte and thus the action of coating the surface of the positive electrode active material cannot be expected from it so much.

The concentration of the electrolyte salt in the nonaqueous electrolyte is not particularly limited but is preferably 0.3 mol/L or more, and more preferably 0.4 mol/L or more, and is preferably 1.7 mol/L or less, and more preferably 1.5 mol/L or less.

Further, a gelling agent including a polymer and the like may be used to make the nonaqueous electrolyte in the form of a gel. Further, a solid electrolyte can be used in the battery of the present invention in place of the nonaqueous electrolyte. For such a solid electrolyte, an inorganic electrolyte as well as an organic electrode can be used, for example.

The nonaqueous secondary battery of the present invention may be in the form of a cylindrical (circular or rectangular cylindrical) battery using, for example, a steel or aluminum outer can. Further, the nonaqueous secondary battery of the present invention may be in the form of a soft package battery using a metal-deposited laminated film as an outer package.

The nonaqueous secondary battery of the present invention can be produced in the same manner as in conventionally-known methods of producing nonaqueous secondary batteries by using the nonaqueous electrolyte, the positive electrode, the negative electrode, the separator and the like as discussed above.

Even when the nonaqueous secondary battery of the present invention is charged at a high voltage, the deterioration of the charge/discharge cycle characteristics can be suppressed. Thus, the nonaqueous secondary battery of the present invention has a high capacity and favorable charge/discharge cycle characteristics. By taking advantage of these characteristics, the battery of the present invention can be preferably used as a power source for a variety of devices such as electronic devices (in particular, portable electronic devices such as portable phones and notebook personal computers), power systems, and conveyances (e.g., electric vehicles and electric bicycles).

Hereinafter, the present invention will be described in detail by way of Examples. It should be noted that the present invention is not limited to the Examples described below. The average particle size of each of the lithium-containing composite oxide (LiNi_{0.5}Mn_{1.5}O₄), the amorphous carbon material and the carbon nanotube used in Examples is D50 measured by a laser diffraction/scattering particle size distribution analyzer “MICROTRAC HRA 9320-X100” manufactured by Honeywell Inc.

### Example 1

<Production of Positive Electrode>

LiNi_{0.5}Mn_{1.5}O₄ in the form of fine particles having an average particle size of 5 μm was used as the positive electrode active material. This active material corresponds to a lithium-containing composite oxide represented by the general formula LiNiₓM_{y}Mn_{2-x-y}O₄, where x is 0.5 and y is 0.

LiSO₃CF₂CF₂CF₂SO₃Li was used as the polyvalent organic metal salt. This polyvalent organic metal salt was dissolved in water to prepare an aqueous solution, the positive electrode active material was immersed in the aqueous solution and then was dried, thus obtaining the positive electrode active material whose surface was coated with the polyvalent organic metal salt (hereinafter, this will be referred to as the surface-coated active material). In the surface-coated active material, the amount of LiSO₃CF₂CF₂CF₂SO₃Li was 0.2 parts by mass with respect to 100 parts by mass of LiNi_{0.5}Mn_{1.5}O₄.

As conductive assistants, 2 parts by mass of amorphous carbon material (interlayer distance: 0.363 nm, specific surface area: 50 m²/g, average particle size: 50 nm) and 1 part by mass of carbon nanotube having an average particle size of 10 μm or less (interlayer distance: 0.343 nm, specific surface area: 270 m²/g) were mixed with each other to obtain a carbon material mixture.

Next, 93 parts by mass of the surface-coated active material, 3 parts by mass of the carbon material mixture, and 4 parts by mass of PVDF were mixed with each other to obtain a positive electrode mixture, and the positive electrode mixture was dispersed in N-methyl-2-pyrolidone (NMP) to prepare a positive electrode mixture containing paste. This positive electrode mixture containing paste was applied onto one side of a current collector made of an aluminum foil having a thickness of 15 μm, and the applied paste was dried to form a positive electrode mixture layer. After pressing forming the positive electrode mixture layer, an aqueous solution in which LiSO₃CF₂CF₂CF₂SO₃Li was dissolved was sprayed to the surface of the positive electrode mixture layer, and was dried at 120° C. to coat the surface of the positive electrode mixture layer with the polyvalent organic metal salt. In the surface part of the spray-coated positive electrode mixture layer, the amount of LiSO₃CF₂CF₂CF₂SO₃Li was 0.1 parts by mass with respect to 100 parts by mass of LiNi_{0.5}Mn_{1.5}O₄. Next, the current collector with the positive electrode mixture layer was cut in a certain size, and leads were welded to an exposed portion of the aluminum foil, thus obtaining a positive electrode. The positive electrode mixture layer obtained had a thickness of 55 μm.

<Production of Negative Electrode>

92 parts by mass of graphite as the negative electrode active material and 8 parts by mass of PVDF were mixed with each other to obtain a negative electrode mixture, and this negative electrode mixture was dispersed in NMP to prepare a negative electrode mixture containing paste. This negative electrode mixture containing paste was applied onto both sides of a current collector made of a copper foil having a thickness of 10 μm, and the applied paste was dried to form negative electrode mixture layers, followed by pressing, thus obtaining a negative electrode. The negative electrode was cut, and leads were welded to an exposed portion of the copper foil, and thereafter, the negative electrode was dried in a vacuum at 120° C. for 15 hours. In the negative electrode obtained, the negative electrode mixture layers each had a thickness of 60 μm (i.e., thickness per one side of the current collector).

<Assembly of Battery>

Two positive electrodes and one negative electrode obtained above were laminated via microporous polyethylene films (thickness: 16 μm) such that the negative electrode was interposed between the positive electrodes and the positive electrode mixture layers and the negative electrode mixture layers opposed each other, and they were fixed with tape, thus obtaining a laminated electrode body. This laminated electrode body and a lithium foil as a reference electrode for measuring a potential were inserted into a laminate film outer package, and the rim of the outer package was sealed by welding except for one portion. Next, in a mixed solvent of ethylene carbonate and diethyl carbonate at a volume ratio of 2:5, LiPF₆ was dissolved at a concentration of 1.2 mol/L, and 1 mass % of propane sultone and 1 mass % of vinylene carbonate were added to the mixed solvent, thus preparing a nonaqueous electrolyte. The nonaqueous electrolyte was injected into the outer package through the unsealed portion of the rim of the outer package, and then the outer package was completely sealed by welding, thus obtaining a nonaqueous secondary battery.

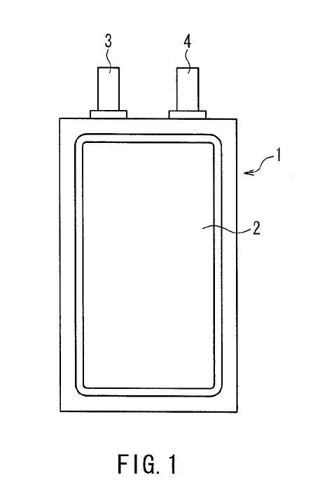

FIG. 1 is a plan view of the nonaqueous secondary battery obtained. In the nonaqueous secondary battery 1 of this example as shown in FIG. 1, the laminated electrode body and the nonaqueous electrolyte are contained in the outer package 2 made of a laminate film having a rectangular shape when seen in a plan view. A positive electrode external terminal 3 and a negative electrode external terminal 4 are drawn out from the same side of the outer package 2. It should be noted that a terminal drawn out from the reference electrode is not shown in FIG. 1.

### Example 2

A positive electrode was produced in the same manner as in Example 1 except that 3 parts by mass of the amorphous carbon material was used solely in place of the carbon material mixture. Except using this positive electrode, a nonaqueous secondary battery was produced in the same manner as in Example 1.

### Example 3

A positive electrode was produced in the same manner as in Example 1 except that 2 parts by mass of the amorphous carbon material and 1 part by mass of graphite were used to obtain a carbon material mixture. Except using this positive electrode, a nonaqueous secondary battery was produced in the same manner as in Example 1.

### Example 4

A positive electrode was produced in the same manner as in Example 1 except that LiCO₂CH₂CH₂CH₂CO₂Li was used as the polyvalent organic metal salt. Except using this positive electrode, a nonaqueous secondary battery was produced in the same manner as in Example 1.

### Example 5

A positive electrode was produced in the same manner as in Example 1 except that LiCO₂C₆H₄CO₂Li was used as the polyvalent organic metal salt. Except using this positive electrode, a nonaqueous secondary battery was produced in the same manner as in Example 1.

### Example 6

A positive electrode was produced in the same manner as in Example 1 except that LiCO₂C₆H₃FCO₂Li was used as the polyvalent organic metal salt. Except using this positive electrode, a nonaqueous secondary battery was produced in the same manner as in Example 1.

### Example 7

A positive electrode was produced in the same manner as in Example 1 except that Mg(CO₂C₆H₃FCO₂) was used as the polyvalent organic metal salt. Except using this positive electrode, a nonaqueous secondary battery was produced in the same manner as in Example 1.

### Example 8

A positive electrode was produced in the same manner as in Example 1 except that the amount of the polyvalent organic metal salt used to coat the surface-coated active material was changed to 2 parts by mass with respect to 100 parts by mass of LiNi_{0.5}Mn_{1.5}O₄. Except using this positive electrode, a nonaqueous secondary battery was produced in the same manner as in Example 1.

### Example 9

A positive electrode mixture containing paste was prepared in the same manner as in Example 1 except that LiNi_{0.5}Mn_{1.5}O₄ whose surface was not coated with the polyvalent organic metal salt was used. This positive electrode mixture containing paste was applied to one side of a current collector made of an aluminum foil having a thickness of 15 μm, and the applied paste was dried to form a positive electrode mixture layer. After press forming the positive electrode mixture layer, an aqueous solution in which LiSO₃CF₂CF₂CF₂SO₃Li was dissolved was sprayed to the surface of the positive electrode mixture layer, and was dried at 120° C. to coat the surface of the positive electrode mixture layer with the polyvalent organic metal salt, thus producing a positive electrode. In the surface part of the spray-coated positive electrode mixture layer, the amount of LiSO₃CF₂CF₂CF₂SO₃Li was 0.1 parts by mass with respect to 100 parts by mass of LiNi_{0.5}Mn_{1.5}O₄. Except using this positive electrode, a nonaqueous secondary battery was produced in the same manner as in Example 1.

### Example 10

A nonaqueous secondary battery was produced in the same manner as in Example 1 except that the solvent of the nonaqueous electrolyte was changed to a mixed solvent of ethylene carbonate, diethyl carbonate and fluorinated ether (HCF₂CF₂CF₂OCF₂CHF₂, manufactured by Daikin Industries, Ltd.) at a volume ratio of 2:2:3.

### Example 11

A nonaqueous secondary battery was produced in the same manner as in Example 1 except that the solvent of the nonaqueous electrolyte was changed to a mixed solvent of ethylene carbonate, diethyl carbonate and fluoroethylene carbonate (4-fluoro-1,3-dioxolane-2-one) at a volume ratio of 2:2:3.

### Comparative Example 1

A positive electrode was produced in the same manner as in Example 1 except that LiNi_{0.5}Mn_{1.5}O₄ whose surface was not coated with the polyvalent organic metal salt was used and the surface of the positive electrode mixture layer was not coated with the polyvalent organic metal salt. Except using this positive electrode, a nonaqueous secondary battery was produced in the same manner as in Example 1.

### Comparative Example 2

A nonaqueous secondary battery was produced in the same manner as in Comparative Example 1 except that the nonaqueous electrolyte used in Example 10 was used.

The charge/discharge cycle characteristics of each of the nonaqueous secondary batteries of Examples 1 to 11 and Comparative Examples 1 to 2 were evaluated as follows. First, each of the batteries was charged at a constant current of 0.2 C until the battery voltage reached 5V, and then was discharged at a constant current of 0.2 C until the final voltage became 3.5V. A series of these operations was determined as 1 cycle, and each of the batteries was charged/discharged until 20 cycles elapsed. Thereafter, each of the batteries was charged at a constant current of 0.2 C until the positive electrode potential became 5V with respect to the reference electrode potential, and then was discharged at a constant current of 1 C until the final voltage became 3.5 V, and the discharge capacity (1 C discharge capacity after 20 cycles of charging/discharging) of each of the batteries was determined. The charge/discharge cycle characteristics of the batteries were evaluated based on relative values with respect to the discharge capacity of the battery of Comparative Example 1 as 100. Table 1 provides the results.

TABLE 1

| | | | Charge/discharge cycle |
|---|---|---|---|
| | Proportion of polyvalent organic metal salt | | characteristics (1 C |
| | (parts by mass) | | discharge capacity after 20 |
| | Interior part of positive | Surface part of positive | cycles of charging/discharging |
| | electrode mixture layer | electrode mixture layer | expressed in relative value) |
| Ex. 1 | 0.2 | 0.3 | 132 |
| Ex. 2 | 0.2 | 0.3 | 121 |
| Ex. 3 | 0.2 | 0.3 | 125 |
| Ex. 4 | 0.2 | 0.3 | 118 |
| Ex. 5 | 0.2 | 0.3 | 125 |
| Ex. 6 | 0.2 | 0.3 | 142 |
| Ex. 7 | 0.2 | 0.3 | 138 |
| Ex. 8 | 2 | 2.1 | 110 |
| Ex. 9 | 0 | 0.1 | 112 |
| Ex. 10 | 0.2 | 0.3 | 155 |
| Ex. 11 | 0.2 | 0.3 | 151 |
| Comp. Ex. 1 | 0 | 0 | 100 |
| Comp. Ex. 2 | 0 | 0 | 102 |

“Proportion of polyvalent organic metal salt” in Table 1 refers to the amount (parts by mass) of the polyvalent organic metal salt with respect to 100 parts by mass of the positive electrode active material.

As can be seen from Table 1, the 1 C discharge capacity of each of the nonaqueous secondary batteries of Examples 1 to 11 was larger than that of the battery of Comparative Example 1 after 20 cycles of charging/discharging, showing that the batteries of Examples 1 to 11 had excellent charge/discharge cycle characteristics.

Further, in comparison with the batteries of Examples 2 and 3 in which amorphous carbon material and fibrous material or carbon nanotube were not used in combination as positive electrode conductive assistants, and the battery of Example 4 using LiCO₂CH₂CH₂CH₂CO₂Li not containing fluorine as the polyvalent organic metal salt, it is clear that the battery of Example 1 had a larger 1 C discharge capacity after 20 cycles of charging/discharging and more favorable charge/discharge cycle characteristics because, in the battery of Example 1, the surface of the positive electrode active material was coated with the fluorine-containing polyvalent organic metal salt LiSO₃CF₂CF₂CF₂SO₃Li and the carbon material mixture of the amorphous carbon material and carbon nanotube was used as the positive electrode conductive assistant.

After the evaluation of the charge/discharge cycle characteristics, the nonaqueous secondary battery of Example 1 was disassembled to take out the positive electrodes, and each positive electrode was analyzed using an X-ray photoelectron spectrometer (XPS) to determine the composition and the chemical conditions on its surface. As a result, F and S were detected from the surface layer, and it was found that F and S were present in the forms of a C—F bond and an S-0 bond, respectively. From these results, it was found that a coating derived from LiSO₃CF₂CF₂CF₂SO₃Li was formed on the surface of each positive electrode.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A nonaqueous secondary battery comprising a positive electrode having a positive electrode mixture layer containing a lithium-containing composite oxide as a positive electrode active material, a negative electrode, a separator, and a nonaqueous electrolyte,
wherein a surface of the positive electrode active material is coated with a polyvalent organic metal salt.

2. The nonaqueous secondary battery according to claim 1, wherein a surface of the positive electrode mixture layer is also coated with a polyvalent organic metal salt.

3. The nonaqueous secondary battery according to claim 1, wherein a proportion of the polyvalent organic metal salt contained in a surface part of the positive electrode mixture layer is larger than that of the polyvalent organic metal salt contained in an interior part of the positive electrode mixture layer.

4. The nonaqueous secondary battery according to claim 1, wherein the polyvalent organic metal salt is fluorine-containing polyvalent organic lithium salt.

5. The nonaqueous secondary battery according to claim 1, wherein the positive electrode mixture layer further contains an amorphous carbon material, and a fibrous carbon material or carbon nanotube.

6. The nonaqueous secondary battery according to claim 1, wherein the lithium-containing composite oxide can be charged to a voltage of 4.4V or higher against lithium when being used.

7. The nonaqueous secondary battery according to claim 6, wherein the lithium-containing composite oxide is represented by the general formula LiNiₓM_{y}Mn_{2-x-y}O₄, where M is at least one metal element other than Ni, Mn and Li, x satisfies 0.4≦x≦0.6, and y satisfies 0≦y≦0.1.

8. A nonaqueous secondary battery comprising a positive electrode having a positive electrode mixture layer containing a lithium-containing composite oxide as a positive electrode active material, a negative electrode, a separator, and a nonaqueous electrolyte,
wherein a surface of the positive electrode mixture layer is coated with a polyvalent organic metal salt.

9. The nonaqueous secondary battery according to claim 8, wherein the polyvalent organic metal salt is a fluorine-containing polyvalent organic lithium salt.

10. The nonaqueous secondary battery according to claim 8, wherein the positive electrode mixture layer further contains an amorphous carbon material, and a fibrous carbon material or carbon nanotube.

11. The nonaqueous secondary battery according to claim 8, wherein the lithium-containing composite oxide can be charged to a voltage of 4.4V or higher against lithium when being used.

12. The nonaqueous secondary battery according to claim 11, wherein the lithium-containing composite oxide is represented by the general formula LiNiₓM_{y}Mn_{2-x-y}O₄, where M is at least one metal element other than Ni, Mn and Li, x satisfies 0.4≦x≦0.6, and y satisfies 0≦y≦0.1.
